(19) United States
(12) Patent Application Publication
(10) Pub. No.: US 2021/0076695 A1
(43) Pub. Date: Mar. 18, 2021

(54) DAIRY PRODUCT AND PROCESS

(71) Applicant: FONTERRA CO-OPERATIVE GROUP LIMITED, Auckland (NZ)

(72) Inventors: Alexandra Kay LEGG, Auckland (NZ); Aurelie Suzanne Bernadette CUCHEVAL, Auckland (NZ); George Thomas FULLER, Auckland (NZ); Hemang BHATT, Auckland (NZ); Mitaben Dhirajlal LAD, Auckland (NZ); Seyed Hashem HOSSEINIPARVAR, Auckland (NZ); Skelte Gerald ANEMA, Auckland (NZ); Therese CONSIDINE, Auckland (NZ)

(21) Appl. No.: 16/954,486

(22) PCT Filed: Dec. 19, 2018
(86) PCT No.: PCT/IB2018/060294

§ 371 Date: Jun. 16, 2020

(30) Foreign Application Priority Data
Dec. 19, 2017 (NZ) 738516

(51) Int. Cl. A23C 13/14

(52) U.S. Cl. CPC A23C 13/14

(57) ABSTRACT

A cream composition comprising lipid, optionally protein, one or more emulsifiers, and one or more thickeners or stabilisers, and having acceptable properties after temperature cycling, including acceptable composition: serum phase viscosity, overrun, change in apparent viscosity, and change in fat globule volume weighted mean diameter (D[4,3]).

### FIELD OF THE INVENTION

The present invention relates to creams and particularly to ultra-high temperature (UHT) creams, coffee creams, and whipping creams as manufactured from fresh cream, suitable dairy ingredients, and other allowed ingredients. Additionally, this invention also relates to the manufacture of UHT cream products by recombined technologies using suitable dairy ingredients, and other allowed ingredients including vegetable fat. The invention also relates to methods of manufacturing such creams and products. The formulation and preparation methods particularly allow the UHT creams and related products to resist destabilisation caused by temperature fluctuations during transportation and storage.

### BACKGROUND TO THE INVENTION

Dairy cream is the enriched fat fraction obtained from whole milk, usually by centrifugal separation. Such creams maintain the original, native milk fat globule membrane to emulsify the fat. Alternatively, creams may be manufactured by blending various concentrated milk fat ingredients with liquid or dry milk ingredients and water to produce recombined cream products. Recombined cream and/or recombined whipping creams are processed with high shear to adequately emulsify the milk fat with the available proteins and/or with added emulsifiers. Cream analogues, non-dairy creams or dairy cream alternatives also may be produced with alternative fat sources, especially plant-based fats, and emulsified with milk proteins, other suitable proteins, and/or other optional allowed ingredients, including emulsifiers and stabilisers.

Numerous creams are made with differing fat contents to simultaneously meet relevant legal regulations and customer functionality expectations. The CODEX Standard for Cream and Prepared Creams (CODEX STAN 288-1976) specifies a minimum fat content of 10% (w/w) for cream [part 3.3 Composition]. Similarly, the US Standards of Identity Title 21 Food and Drugs specify that “cream” must contain ≥18% milk fat [§ 131.3(a)], Heavy Whipping cream must contain 36% milk fat [§ 131.150], Light cream must contain ≥18% but ≤30% milk fat [§ 131.155], and Light whipping cream must contain ≥30% but ≤36% milk fat [§ 131.157]. Whipping creams usually contain ≥30% milk fat to enhance whipping ability and functionality.

The regulations adopted in many countries also allow the addition of selected functional ingredients to various creams. For example, CODEX Standard for Cream and Prepared Creams, section 4, Food Additives (CODEX STAN 288-1976) allows the addition of ingredients specifically identified as stabilisers, acidity regulators, thickeners and emulsifiers, and packaging gases and propellants. This CODEX section then specifically identifies each individual allowed ingredient within these broad classifications. Relevant US 21 CFR sections similarly allow creams to contain ingredients identified as emulsifiers, stabilisers, and nutritive sweeteners.

Creams routinely receive pasteurization heat treatments to destroy pathogenic microorganisms. However, some spoilage microorganisms survive pasteurization, so pasteurized creams still require refrigerated storage to inhibit microbial growth and provide an acceptable shelf-life. Alternatively, creams may be processed with higher heat treatments defined as sterilisation such as ultra-high heat treatments (UHT). Although UHT treatments prevent microbial growth and spoilage at ambient temperatures, temperature fluctuations during ambient storage and distribution or non-temperature controlled storage can cause undesirable physical changes including phase separation, thickening, and/or solidification.

A major problem in supplying UHT creams and/or whipping creams across different markets is the break in the continuous refrigeration or “cold chain” at various points of the supply chain, for example, during storage, transportation and/or display. In some Asian and Middle Eastern markets, local ambient temperatures can exceed 35° C. Exposure to temperature fluctuations promotes cream defects such as turning solid, difficulty in pouring, increased or decreased whipping time, decreased overrun, and decreased ability to retain desired whipped shapes.

Many reports state that UHT creams are particularly sensitive to temperature fluctuations during storage and transportation, which produce quality defects (Hoffmann, W. (1999), Storage stability of UHT whipping cream, Kieler Milchwirtschaftliche Forschungsberichte 51(2), 125-136). Hoffmann reports that two groups of UHT creams were stored at 5° C. or 20° C. for 11 weeks, and a third group was stored at 20° C. for 11 weeks following an initial warming to 35° C. for 15 minutes to simulate transportation in summer months. The initial warming to 35° C. in the third group adversely affected storage stability, increasing separation during subsequent storage at 20° C. and thickening after whipping.

It is an object of the invention to provide improved or alternative cream products.

Other objects of the invention may become apparent from the following description which is given by way of example only. In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### SUMMARY OF THE INVENTION

Accordingly, the invention broadly comprises a cream composition comprising lipid, optionally protein, one or more emulsifiers, and one or more thickeners or stabilisers, and having acceptable properties after temperature cycling, including acceptable composition:serum phase viscosity, overrun, change in apparent viscosity, and change in fat globule volume weighted mean diameter (D[4,3]).

In one aspect the invention provides a cream composition, such as a UHT whipping cream composition comprising
a) about 25% to about 40% by weight lipid, the lipid comprising one or more mammalian milk lipids;
b) about 0% to about 3%, preferably about 0.5% to about 3% by weight protein;
c) about 0.01% to about 1.0% by weight of one or more emulsifiers;
d) about 0.05% to about 5%, preferably to about 0.3% by weight of one or more thickeners or stabilisers.

In one aspect the invention provides a cream composition, such as a UHT whipping cream composition comprising
a) about 25% to about 40% by weight lipid, the lipid comprising one or more mammalian milk lipids;
b) about 0% to about 3%, preferably about 0.5% to about 3% by weight protein;
c) about 0.01% to about 1.0% by weight of one or more emulsifiers;
d) about 0.05% to about 3% by weight of one or more thickeners or stabilisers.

In another aspect the invention provides a cream composition, such as a UHT whipping cream composition comprising
a) about 25% to about 40% by weight lipid, the lipid comprising one or more mammalian milk lipids;
b) about 0% to about 3%, preferably about 0.5% to about 3% by weight protein;
c) about 0.01% to about 1.0% by weight of one or more emulsifiers;
d) about 0.05% to about 5%, preferably to about 0.3% by weight of one or more thickeners or stabilisers;

wherein
e) the ratio of the viscosity of the composition to the viscosity of an extracted aqueous phase of the composition is less than about 20 when measured at a shear rate of 1 s⁻¹ at 5° C.; and/or
f) the composition exhibits an overrun of at least about 80% when whipped at 4 to 10° C. using a bowl and whisk; and/or
g) the composition exhibits a change in apparent viscosity of less than about 100% measured at a shear rate of 1 s⁻¹ at 5° C. after holding at 25° C. for 24 hours followed by holding at 10° C. for 24 hours; and/or
h) the composition exhibits a change in fat globule volume weighted mean diameter (D[4,3]) of less than about 100% after holding at 25° C. for 24 hours followed by holding at 10° C. for 24 hours.

In another aspect the invention provides a cream composition, such as a UHT whipping cream composition comprising
a) about 25% to about 40% by weight lipid, the lipid comprising one or more mammalian milk lipids;
b) about 0% to about 3%, preferably about 0.5% to about 3% by weight protein;
c) about 0.01% to about 1.0% by weight of one or more emulsifiers;
d) about 0.05% to about 3% by weight of one or more thickeners or stabilisers;

wherein
e) the ratio of the viscosity of the composition to the viscosity of an extracted aqueous phase of the composition is less than about 20 when measured at a shear rate of 1 s⁻¹ at 5° C.; and/or
f) the composition exhibits an overrun of at least about 80% when whipped at 4 to 10° C. using a bowl and whisk; and/or
g) the composition exhibits a change in apparent viscosity of less than about 100% measured at a shear rate of 1 s⁻¹ at 5° C. after holding at 25° C. for 24 hours followed by holding at 10° C. for 24 hours; and/or
h) the composition exhibits a change in fat globule volume weighted mean diameter (D[4,3]) of less than about 100% after holding at 25° C. for 24 hours followed by holding at 10° C. for 24 hours.

The following embodiments may relate to any of the above aspects in any combination.

In various embodiments the composition may comprise about 25% to about 40% by weight lipid, the lipid comprising one or more mammalian milk lipids, preferably one or more bovine milk lipids, selected from the group consisting of cream, high fat cream, reconstituted cream powder, anhydrous milk fat (AMF), ghee, butter, β-serum powder, whole milk powder (WMP), high fat milk protein concentrate, or any combination of any two or more thereof, the lipid optionally further comprising one or more refined and/or hydrogenated vegetable fat sources selected from the group consisting of palm, palm kernel, coconut, soybean, rapeseed, cottonseed, sunflower seed, corn, safflower seed, rice bran oil, sesame oil, olive oil, fractions thereof, or any combination of any two or more thereof. In various embodiments the composition may comprise any two or more, or any three or more, or any four or more of these components. Preferably the lipid comprises cream, high fat cream, reconstituted cream powder, anhydrous milk fat (AMF), or any combination of any two or more thereof.

In various embodiments the composition may comprise about 25, 27, 30, 33, 35, 37, or 40% by weight lipid, and useful ranges may be selected between any of these values (for example, about 25 to about 40, about 25 to about 35, about 25 to about 30, about 27 to about 40, about 30 to about 40, about 33 to about 40, about 35 to about 40, or about 37 to about 40%).

In various embodiments the composition may comprise about 0% to about 3% by weight protein, preferably one or more mammalian milk proteins, preferably one or more bovine milk proteins, wherein the protein comprises or comprises a source of protein selected from the group consisting of milk, skim milk, cream, whole milk, whole milk powder (WMP), skim milk powder (SMP), buttermilk powder (BMP), caseinate, sodium caseinate, calcium caseinate, whey protein concentrate (WPC), whey protein isolate (WPI), milk protein isolate (MPI), milk protein concentrate (MPC), modified MPC derivatives, micellar casein, the protein optionally further comprising one or more non-dairy sources selected from plant or animal sources such as soy protein or egg protein, or any combination of any two or more thereof. In various embodiments the composition may comprise any two or more, or any three or more, or any four or more of these components. Preferably the protein comprises milk, skim milk, cream, whole milk, whole milk powder (WMP), skim milk powder (SMP), buttermilk powder (BMP), caseinate, sodium caseinate, calcium caseinate, whey protein concentrate (WPC), whey protein isolate (WPI), milk protein isolate (MPI), milk protein concentrate (MPC), modified MPC derivatives, micellar casein, or any combination of any two or more thereof.

In various embodiments the composition may comprise about 0, 0.25, 0.5, 0.75, 1, 1.25, 1.5, 1.75, 2, 2.25, 2.5, 2.75, or 3% by weight protein, and useful ranges may be selected between any of these values (for example, about 0 to about 3, 0.5 to about 1.5, about 0.5 to about 3, about 1 to about 2, about 1 to about 3, about 1.5 to about 2.5, about 1.5 to about 3, about 2 to about 3, or about 2.5 to about 3%).

In various embodiments the composition may comprise about 0.01% to about 1.0% by weight of one or more emulsifiers selected from the group consisting of protein, phospholipids, including phospholipids from milkfat globule membrane, buttermilk powder, β-serum powder (the dried aqueous phase removed from pasteurised dairy cream during the manufacture of AMF), or an emulsifier listed in Codex Standard 288-1976 for creams such as lecithin, mono and diglycerides, distilled monoglycerides, acid esters of mono-diglycerides including lactic, citric, acetic, diacetyltartaric and tartaric, polysorbates (Tweens), sorbitan esters of fatty acids (SPANS), sucrose esters, polyglycerol esters of fatty acids, propylene glycol esters of fatty acids, sodium or calcium stearoyl lactylate, or any combination of any two or more thereof. In various embodiments the composition may comprise any two or more, or any three or more, or any four or more of these components. Preferably the one or more emulsifiers are selected from the group consisting of protein, phospholipids from milkfat globule membrane, buttermilk powder, β-serum powder, lecithin, mono and diglycerides, distilled monoglycerides, acid esters of mono-diglycerides including lactic, citric, acetic, diacetyltartaric and tartaric, polysorbates, sorbitan esters of fatty acids, sucrose esters, polyglycerol esters of fatty acids, propylene glycol esters of fatty acids, sodium or calcium stearoyl lactylate, or any combination of any two or more thereof. More preferably the one or more emulsifiers comprise two or more of lecithin, mono and diglycerides, polysorbates, sucrose esters, and propylene glycol esters of fatty acids.

In various embodiments the composition may comprise about 0.01, 0.025, 0.05, 0.075, 0.1, 0.2, 0.3, 0.4, 0.5, 0.6, 0.7, 0.8, 0.9, or 1.0% by weight of one or more emulsifiers, and useful ranges may be selected between any of these values (for example, about 0.01 to about 1.0, about 0.025 to about 1.0, about 0.05 to about 1.0, about 0.075 to about 1.0, about 0.1 to about 1.0, about 0.2 to about 1.0, about 0.4 to about 1.0, about 0.5 to about 1.0, or about 0.6 to about 1.0%).

In various embodiments the composition may comprise about 0.05% to about 5%, preferably to about 0.3%, or about 0.05% to about 3% by weight of one or more thickeners or stabilisers selected from the group consisting of, for example, carrageenan, guar gum, locust bean gum, Tara gum, gellan gum, xanthan gum ,acacia gum, microcrystalline cellulose (MCC), carboxymethyl cellulose (CMC), cellulose derivatives, propylene glycol alginate, sodium alginate, pectin, gelatin, starch, starch derivatives, citrus fibre, or any combination of any two or more thereof. In various embodiments the composition may comprise any two or more, or any three or more, or any four or more of these components. Preferably the one or more thickeners or stabilisers are selected from the group consisting of carrageenan, guar gum, locust bean gum, Tara gum, gellan gum, xanthan gum, acacia gum, microcrystalline cellulose (MCC), carboxymethyl cellulose (CMC), cellulose derivatives, propylene glycol alginate, sodium alginate, pectin, gelatin, starch or starch derivatives, or citrus fibre, or any combination of any two or more thereof. More preferably the one or more thickeners or stabilisers comprise xanthan, carrageenan, and guar gum.

In various embodiments the composition may comprise about 0.05, 0.075, 0.1, 0.15, 0.2, 0.25, 0.3, 0.4, 0.5, 0.6, 0.7, 0.8, 0.9, 1, 1.5, 2, 2.5, 3, 3.5, 4, 4.5, or 5% by weight of one or more thickeners or stabilisers, and useful ranges may be selected between any of these values (for example, about 0.05 to about 5, about 0.05 to about 4, about 0.05 to about 3, about 0.05 to about 2, about 0.05 to about 1, about 0.05 to about 0.9, about 0.05 to about 0.8, about 0.05 to about 0.7, about 0.05 to about 0.6, about 0.05 to about 0.5, about 0.05 to about 0.4, or about 0.05 to about 0.3%).

In various embodiments the ratio of the viscosity of the composition to the viscosity of an extracted aqueous phase of the composition may be about or less than about 20, 18, 17, 16, 15, 14, 13, 12, 11, 10, 9, or 8 when measured at a shear rate of 1 s⁻¹ at 5° C., and useful ranges may be selected between any of these values (for example, about or less than about 8 to about 20, about 8 to about 18, or about 8 to about 12). Preferably the ratio is less than about 20 or less than about 9.

In various embodiments the composition may exhibit an overrun of at least about 80, 85, 90, 95, 100, 105, 110, 115, or 120% when whipped at 4 to 10° C. using a bowl and whisk and useful ranges may be selected between any of these values (for example, about 80 to about 120, about 90 to about 120, about 100 to about 120, or about 110 to about 120%). Preferably the overrun is at least about 100 or about 120%. In some embodiments, the UHT whipping cream composition maintains an overrun following whipping of greater than about 150%, for example greater than about 160%, greater than about 170%, greater than about 180%, greater than about 190%, or greater than about 200%.

In various embodiments the composition may exhibit a change in apparent viscosity of less than about 50, 55, 60, 65, 70, 75, 80, 85, 90, 95, or 100% measured at a shear rate of 1 s⁻¹ at 5° C. after holding at 25° C. for 24 hours followed by holding at 10° C. for 24 hours, and useful ranges may be selected between any of these values (for example, about 50 to about 100, about 50 to about 90, about 50 to about 80, or about 60 to about 100%). Preferably the change is less than about 100% or less than about 50%.

In various embodiments the composition may exhibit a change in apparent viscosity of less than about 50, 55, 60, 65, 70, 75, 80, 85, 90, 95, or 100% measured at a shear rate of 1 s⁻¹ at 5° C. after two, or three or more cycles of holding at 25° C. or 30° C. for 24 hours followed by holding at 10° C. for 24 hours, and useful ranges may be selected between any of these values (for example, about 50 to about 100, about 50 to about 90, about 50 to about 80, or about 60 to about 100%). Preferably the change is less than about 100% or less than about 50%.

In various embodiments the composition may exhibit a change in apparent viscosity of less than about 50, 55, 60, 65, 70, 75, 80, 85, 90, 95, or 100% measured at a shear rate of 1 s⁻¹ at 5° C. after one, two, or three or more cycles of holding at 30° C. for 24 hours followed by holding at 10° C. for 24 hours, and useful ranges may be selected between any of these values (for example, about 50 to about 100, about 50 to about 90, about 50 to about 80, or about 60 to about 100%). Preferably the change is less than about 100% or less than about 50%.

In various embodiments the composition may exhibit a change in fat globule volume weighted mean diameter (D[4,3]) of less than about 50, 55, 60, 65, 70, 75, 80, 85, 90, 95, or 100% after holding at 25° C. for 24 hours followed by holding at 10° C. for 24 hours, and useful ranges may be selected between any of these values (for example, about 50 to about 100, about 50 to about 90, about 50 to about 80, or about 60 to about 100%). Preferably the change is less than about 100% or less than about 50%.

In various embodiments the composition may exhibit acceptable pourability, where the composition pours from the pack without sticking, or lumping after one, two, or three or more cycles of holding at 25° C. for 24 hours followed by holding at 10° C. for 24 hours.

In certain embodiments, the UHT whipping cream may further comprise a buffering or chelating salt, preferably about 0 to about 0.03% by weight, for example about 0.01 to about 0.025% by weight of the buffering or chelating salt. Buffering or chelating salts can be selected from but not limited to, orthophosphates, polyphosphates and citrates, or any combination of any two or more thereof. For example, in certain exemplary embodiments the buffering or chelating salt is a polyphosphate salt, such as sodium or potassium polyphosphate.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

The term “comprising” as used in this specification means “consisting at least in part of”. When interpreting statements in this specification which include that term, the features, prefaced by that term in each statement or claim, all need to be present but other features can also be present. Related terms such as “comprise” and “comprised” are to be interpreted in the same manner.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

FIG. 1 shows a plot of % change in apparent viscosity against the ratio of composition:aqueous phase viscosity for compositions of the present invention (black box, points 1 to 5) and comparator commercially available compositions (C1 to C5) where commonly numbered points are duplicate assessments of the same composition.

### DETAILED DESCRIPTION OF THE INVENTION

This application provides UHT creams and/or whipping creams comprising a specific combination of ingredients resulting in a temperature robust, stable cream that can withstand temperature fluctuations while maintaining functionality and avoiding defects.

Furthermore, the present invention provides UHT creams and/or whipping creams compositions resistant to temperature cycling, temperature fluctuations, tempering and/or heat-shock having excellent stability, pourable, good whipping ability and functionality.

More specifically, the present application relates to compositions comprising combinations of fat, protein, emulsifiers and stabilisers that have a direct impact on the temperature stability of the UHT cream.

In certain embodiments, the UHT cream comprises a fat content of about 25 to about 40% by weight, for example 25-35%, or 25-30%. For example in exemplary embodiments of the UHT cream composition, the fat content is about 30-35% by weight. The fat can be derived from any source, preferably from a dairy source, for example cream, fresh cream, high fat cream, reconstituted cream powder, anhydrous milk fat, buttermilk powder, high fat milk protein concentrate, β-serum powder, butter, or whole milk powder. In various embodiments, non-dairy fats are excluded.

In certain embodiments, the UHT cream comprises a protein content of about 0 to about 3% by weight, for example about 1 to about 2% or about 1.5 to about 2.5%. For example, in certain exemplary embodiments of the UHT cream composition, the protein content is about 0.5 to about 1.5%. The protein can be derived from any source, preferably a dairy source, for example milk, whole milk, whole milk powder, skim milk, skim milk powder, buttermilk powder (BMP), caseinate, sodium caseinate, calcium caseinate, whey protein concentrate, whey protein isolate, milk protein isolate, milk protein concentrate, or modified MPCs or micellar casein. In various embodiments, non-dairy proteins are excluded.

In certain embodiments, the UHT cream comprises an emulsifier content of about 0.05 to about 1.0% by weight, for example about 0.075 to about 0.5%, or about 0.1 to about 0.3%. For example, in exemplary embodiments of the UHT cream composition, the emulsifier content is about 0.25 to about 0.35%. Emulsifiers can be selected from dairy and non-dairy emulsifiers, for example but not limited to, protein, phospholipids from milkfat globule membrane, buttermilk powder, β-serum powder, lecithin, mono and diglycerides, polysorbates or Tweens, sucrose esters, lactic acid esters of mono-diglycerides (Lactem), citric acid esters of mono-diglycerides (Citrem), acetic acid esters of mono-diglycerides, polyglycerol esters of fatty acids.

The inventors, without wishing to be bound by theory, believe that temperature cycling (at least one cycle of elevated temperature, generally above room temperature, typically above 20° C. or 25° C.) can thicken and solidify UHT creams by promoting the formation of molecular bridges between dispersed fat globules and a combination of proteins and stabilisers. Temperature cycling initially melts, and then subsequently recrystallizes dispersed fat globules. The fat globules also contain added emulsifier within both the fat globule core and as adsorbed components upon the globule surface. Temperature cycling promotes interactions between proteins and stabilisers with additional emulsifier that is present within the aqueous phase. Such interactions create a molecular network during temperature cycling that entangles the fat globules, particularly as the fat globules recrystallize during cooling. The emulsifier—protein—stabiliser—entangled fat globule network grows into structures that initially thicken, and can potentially solidify the cream.

The present invention overcomes this problem by providing creams that minimize component interactions, thereby preventing bridge formation between the emulsifiers, protein, stabilisers and fat globules. The ratio of the viscosity of the original cream to the viscosity of the aqueous phase indicates the extent of fat globule interaction and entrapment with other relevant components. A low viscosity ratio shows minimal fat globule-to-fat globule interactions, thereby producing UHT creams that are not bound within a protein—stabiliser—aqueous emulsifier molecular matrix. Such systems are stable to temperature cycling. In the present invention, minimal fat globule interactions and maximum temperature cycling stability are achieved by designing creams to achieve an original cream to extracted aqueous phase viscosity ratio of less than about 20, or less than about 10.

Temperature cycling may also promote irreversible coalescence between fat globules in UHT creams to thicken and solidify the UHT cream. The present invention solves this problem by creating fat globules that sufficiently repulse other fat globules. By preventing the necessary close contact between fat globules, the present invention eliminates the opportunity for partial coalescence. Therefore, the UHT cream cannot thicken or solidify throughout temperature cycling.

In certain embodiments, the UHT cream comprises a stabiliser content of 0.05-0.2% by weight, for example 0.075-0.175%. For example, in certain exemplary embodiments, the stabiliser content is 0.075-0.1%. Stabilisers can be selected from or a blend of carrageenan, guar gum, locust bean gum, Tara gum, gellan gum, xanthan gum, gum acacia, xanthan, microcrystalline cellulose (MCC), carboxymethyl cellulose (CMC), cellulose derivatives, propylene glycol alginate, alginate, pectin, gelatin, or citrus fibre or combinations thereof. In certain embodiments, the stabiliser comprises up to 5% by weight of starch or starch derivatives.

In certain embodiments, the UHT cream comprises a buffering or chelating salt content of 0-0.03% by weight, for example 0.01-0.025%. Buffering salts can be selected from but not limited to, orthophosphates, polyphosphates and citrates. For example, in certain exemplary embodiments the chelator is a polyphosphate salt such as sodium or potassium polyphosphate.

In certain embodiments, the UHT cream is temperature robust and ambient stable between the temperatures of 4° C. to 25° C. Preferably the UHT cream is temperature/ambient stable between the temperatures of 4° C. to 40° C.

In certain embodiments, the UHT cream is temperature/ambient stable after multiple temperature cycles. Preferably, the UHT cream is temperature/ambient stable after 1, 2, 3, 4, 5, 6, or 7 temperature cycles. Even more preferably, the UHT cream is temperature/ambient stable after 10 cycles.

The term “temperature cycling” refers to the sequential changes in temperature of the cream, for example, the change in cream temperature from refrigeration to ambient, and then returning to refrigeration.

Temperature cycling usually increases product viscosity, which frequently becomes high enough to solidify or gel the cream within the package. Other major temperature cycling UHT cream defects include increased difficulties pouring the cream, enhanced stratification into separate layers (creaming or serum separation), inhibited whipping ability and greatly increased or reduced whipping times, exuded free serum, depressed whipped volume (low overrun), and decreased ability to maintain desired whipped shapes on storage, i.e. piped rosette shapes are too soft or too firm with an unacceptable appearance. Therefore, despite possessing microbiological stability, UHT creams and whipping creams must receive continuous refrigeration to preserve quality and functionality.

Good temperature/ambient stability, when used herein with reference to UHT creams contemplate compositions retaining a pourable liquid state, including for example liquid compositions in which essentially no solidification, or gelation is observed, following temperature cycling events.

A liquid cream of this invention can be obtained by dispersing and dissolving the required amounts of non-fat dairy ingredients, thickeners or stabilisers, buffering salts, hydrophilic emulsifiers or any other optional ingredients such as flavours, sugars or polyols, in water if a recombined system, or in the skim milk phase if made from fresh liquid ingredients. Fat soluble ingredients such as lipophilic emulsifiers are added to the fat phase—melted milkfat if a recombined system or fresh liquid cream. The fat phase and the aqueous phase at 60-80° C. are mixed, preheated to 90° C. and then given a UHT (ultra-high temperature) treatment using direct steam injection and flash cooling or indirect heating via a heat exchanger at 130-150° C./1-20 s, homogenised and cooled. Known methods for aseptic filling and packaging may be used.

### EXAMPLES 1-5

### 1. General Methods

### 1.1 Temperature Cycling

Each cream was either temperature cycled in the unopened, original packaging or subsampled into a sterile container. To prevent microbial growth, 0.02 wt % of sodium azide was added to all subsampled creams from a 20 wt % stock solution. Prior to temperature cycling, all creams were first chilled to 5° C. for at least 24 h. In order to complete 1 cycle from 25 to 10° C., the creams were then transferred to a temperature controlled storage unit maintained at 25° C. for 24 h followed by storage for 24 h in a separate temperature controlled storage unit maintained at 10° C. All cycled creams were then transferred back to chilled storage (5° C.) for 24 h before further testing.

### 1.2 Aqueous Phase Extraction

Approximately 25 to 30 g of each cream was transferred to a 50 mL centrifuge tube. The tubes were then placed in an oven at 50° C. for 1 h in order to melt the milkfat before being transferred to a centrifuge rotor pre-heated to 40° C. inside a centrifuge (Beckman Coulter Avanti J-E centrifuge, JA-14.50 rotor). The samples were centrifuged at 15,000×g for 1 h at 40° C. After centrifugation, the fat depleted aqueous phase was extracted using a 20 mL syringe fitted with a 1.20×38 mm needle. The needle was carefully pushed through the fat layer and the aqueous phase was gently removed, taking care not to extract any of the fatty cream or sediment phases. The extracted aqueous phases were then stored at 5° C. until the viscosity was tested.

### 1.3 Viscosity Measurement and Viscosity Ratio Calculation

The flow behaviour of the original cream and extracted aqueous phase was measured using a shear rate sweep from 0.01 to 100 s⁻¹ at 5° C. in a cup and bob geometry fitted to a DSR502 rheometer (Anton Paar). The apparent viscosity of the original cream and the extracted aqueous phase was determined from the flow curve at 1 s-1.

The apparent viscosity ratio (ηᵣ) of the original cream and the extracted aqueous phase was determined from the following equation.

$${η}_{r} = \frac{{η}_{o}}{{η}_{a}}$$

where ηₒ and ηₐare the apparent viscosities of the original cream and aqueous phase respectively.

The change in apparent viscosity of the original cream after temperature cycling was determined from the following equation.

$$\% change = \frac{{η}_{o uncycled} - {η}_{o cycled}}{{η}_{o uncycled}} \times 100$$

### 1.4 Fat Globule Size Measurement

The volume weighted mean diameter D[4,3] of each cream was calculated from the fat globule size distribution measured by laser light scattering using a Mastersizer 2000 (Malvern Instruments). One part cream was gently mixed with nine parts of a dissociating agent known as Walstra's solution and held statically for 10 min before being analysed. Walstra's solution was prepared by mixing 0.375 wt % ethylenediaminetetraacetic acid (EDTA) and 0.125 wt % Tween 20 with deionised water and then adjusting the pH to 10 with 0.1 M sodium hydroxide.

The percent difference in the D[4,3] value before and after temperature cycling was determined from the following equation

$$\% difference = \frac{{D}_{4 , 3 uncycled} - {D}_{4 , 3 cycled}}{{D}_{4 , 3 uncycled}} \times 100$$

### 1.5 Whipping Method and Analysis

Creams were whipped to firm peak using either a Kitchen-Aid mixer (model 5K5SS) on speed 8 or Kenwood mixer (Titanium Major model KM023) on speed 6 equipped with a wire whisk. Both the bowl and whisk were chilled at 5° C. for 10 min before weighing and whipping 400 g of cream. Firm peak was visually determined by an experienced operator. Typically firm peak is reached when the whipped cream pulls away from the sides of the bowl and the whipped cream forms a distinctive firm and stable peak on the tip of the inverted whisk. To determine the overrun at firm peak, the weight of the unwhipped cream and whipped cream were independently measured in a 120 ml cup. Overrun was calculated using the following equation

$$\% Overrun = \frac{Unwhipped weight - Whipped weig ht}{Whipped weight} \times 100$$

### 1.6 Pourability

Without shaking the container, the cream was poured into a beaker and the thickness and smoothness of the cream was observed as it was poured. The cream was considered pourable if it was liquid, not a paste, and flowed from the container by tilting it.

### 2. Compositions

The composition of Table la (Ex 1) was prepared by the following process.
1) Dry blend emulsifiers: lecithin, mono-diglyceride and propylene glycol monostearate (PGMS).
2) Dry blend MPC, stabiliser blend and sodium polyphosphate.
3) Melt AMF at 40 to 45° C.
4) Add demineralised water (65° C.) to a mixing tank and maintain temperature at 65° C.
5) Slowly add emulsifier blend with slow stirring. Mix for 5 min.
6) Slowly add protein, stabiliser and sodium polyphosphate blend. Mix for 5 min.
7) Add melted AMF to the mixing tank and continue mixing.
8) Recirculate the resulting coarse cream emulsion through a back pressure valve at 4 bar for 15 min.
9) Homogenise the coarse cream emulsion at 10 bar.
10) Process the cream by preheating to 90° C. and then indirect UHT treatment at 142° C./4 s at a flow rate of 120 kg/h.
11) Homogenise at 60-85° C. at 50 bar.
12) Cool and package aseptically.

TABLE 1a
Ex 1 composition

| Ingredients | Wt % |
|---|---|
| Anhydrous milk fat (AMF) | 30.49 |
| Milk protein concentrate (80% protein) | 0.61 |
| Demineralised water | 68.52 |
| Stabiliser blend of xanthan, carrageenan, guar gum | 0.1 |
| Lecithin | 0.1 |
| Mono-diglyceride | 0.1 |
| Propylene glycol monostearate (PGMS) | 0.08 |
| Sodium polyphosphate | 0.02 |
| Total | 100.00 |

The compositions of Table 1b (Ex 2-Ex 5) were prepared by an equivalent process depending on whether the lipid and protein ingredients were liquids or powders, using alternative ingredients as indicated.

TABLE 1b
Gross composition of Ex 1 to Ex 5

| Cream | Protein, % | Fat, % | Carbohydrate, % | Stabiliser(s) | Emulsifier(s) |
|---|---|---|---|---|---|
| Ex 1 | 0.5 | 30.5 | 0.03 | Carrageenan, | Lecithin, |
| (as | | | | xanthan, | mono/diglycerides, |
| above) | | | | guar gum | PGMS |
| Ex 2 | 2.3 | 30 | 3.8 | Carrageenan, | Sucrose stearate, |
| | | | | xanthan, | polysorbate |
| | | | | guar gum | |
| Ex 3 | 1.5 | 30.5 | 2.1 | Carrageenan, | Sucrose stearate, |
| | | | | xanthan, | mono/diglycerides, |
| | | | | guar gum | polysorbate |
| Ex 4 | 2.6 | 30.5 | 3.3 | Carrageenan, | Mono/diglycerides, |
| | | | | xanthan, | lecithin, |
| | | | | guar gum | polysorbate |
| Ex 5 | 2.3 | 30 | 3.8 | Carrageenan, | Sucrose stearate, |
| | | | | xanthan, | polysorbate |
| | | | | guar gum | |

By way of comparison, five commercially available whipping cream products (C1 to C5) were obtained and tested, and determined to have the compositions of Table 1c.

TABLE 1c
Gross composition of C1 to C5

| Cream | Protein, % | Fat, % | Carbohydrate, % | Stabiliser(s) | Emulsifier(s) |
|---|---|---|---|---|---|
| C1 | 1.6 | 28 | 5.4 | Gellan gum, | Lecithin, |
| | | | | MCC, Na-CMC | mono/diglycerides |
| C2 | 2.2 | 34.8 | 3.2 | Carrageenan, | — |
| | | | | Na-CMC, MCC | |
| C3 | 2.1 | 35.1 | 2.9 | Carrageenan | — |
| C4 | 2.0 | 35.1 | 3.1 | Carrageenan | — |
| C5 | 2.4 | 35.5 | 3.1 | Carrageenan, | Mono/diglycerides, |
| | | | | xanthan, | polysorbate |
| | | | | guar gum | |

### 3. Results

The compositions of Tables 1a to 1c were evaluated by the aforementioned test methods and a summary of the results is presented in Table 2. All products were cooled to 5° C. before testing.

TABLE 2
Characteristics of the creams

| | | | | | | Post-cycling* | | | |
|---|---|---|---|---|---|---|---|---|---|
| | | | | | | | % | Cream | |
| | Pre-cycling | | | | | | change | FG | % |
| | | | Viscosity | Cream | | | in | D4,3 | change |
| | | | ratio | FG | | | viscosity | after | in D4,3 |
| | CAV^{a} | APAV^{b} | (no | D4,3 | Overrun | CAV^{a} | after | cycling | after |
| Sample | (mPa · s) | (mPa · s) | units) | (μm) | (%) | (mPa · s) | cycling | (μm) | cycling |
| C1 | 8810.00 | 142.00 | 62.04 | 3.83 | 220 | 24800 | 181.50 | 4.46 | 16.54 |
| C2 | 28700.00 | 8.60 | 3337.21 | 6.45 | 106 | 34700 | 20.91 | 8.44 | 30.84 |
| C3 | 105.00 | 1.87 | 56.15 | 2.19 | 166 | 228 | 117.14 | 2.14 | −1.97 |
| C4 | 95.40 | 3.42 | 27.89 | 2.93 | 158 | 144 | 50.94 | 2.87 | −1.91 |
| C5 | 636.00 | 67.10 | 9.48 | 1.36 | 126 | 1410 | 121.70 | 1.39 | 2.50 |
| Ex 1 | 104.00 | 300.00 | 0.35 | 2.36 | 148 | 97.8 | −5.96 | 2.43 | 3.22 |
| Ex 2 | 474.00 | 164.00 | 2.89 | 1.20 | 225 | 541 | 14.14 | 1.20 | 0.08 |
| Ex 3 | 144.00 | 45.30 | 3.18 | 2.14 | 187 | 168 | 16.67 | 2.59 | 20.78 |
| Ex 4 | 365.00 | 70.10 | 5.21 | nd | 154 | 662 | 81.37 | nd | nd |
| Ex 5 | 738.00 | 124.00 | 5.95 | 1.43 | 142 | 494 | −33.06 | 1.42 | −0.91 |

Notes to Table 2:
^{a}composition apparent viscosity;
^{b}aqueous phase apparent viscosity;
*1 cycle from 25 to 10° C.

After temperature cycling, the composition Ex 1 of Table 1a had a cream: aqueous viscosity ratio <10, and a change in cream viscosity of −6%. The change in mean fat globule size was only ˜3%, indicating virtually no partial coalescence had occurred on incomplete melting and re-crystallisation of milkfat in the fat globules on cooling. The cream retained its whipping performance with an overrun of ˜150% and thus exhibited robustness to temperature cycling. In contrast, comparative example C5, although it still whipped after temperature cycling, showed a marked thickening (increase in cream viscosity) greater than 100%.

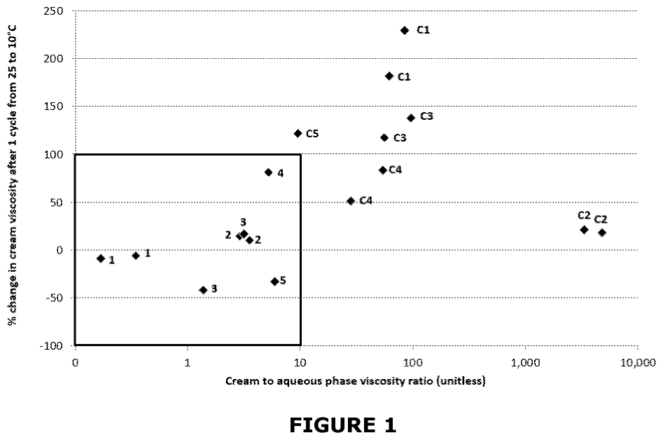

The cream to aqueous phase viscosity of temperature cycled comparative compositions C1-C5 are plotted in FIG. 1, as are those of the examples of the present invention (Ex 1 to Ex 5) that fall into the boxed area of the graph.

### EXAMPLES 6-10

### 1. Compositions

The compositions of Tables 3 and 4 (Ex 6-8) were prepared by the following process.
1) Weigh out AMF for each formulation and place in ˜50° C. waterbath to melt the fat.
2) Add lecithin, mono-diglycerides, PGMS to AMF and stir.
3) Weigh out water into stainless beakers and place in waterbath at 65° C.
4) Dry blend MPC, stabiliser blend and polyphosphate and add slowly to vortex of warmed water. Once added, cover and mix for 10 minutes.
5) Remove from water bath and add molten AMF-emulsifier blend and subject to high shear mixing (Ultraturrax) for 3 minutes at maximum rpm. Replace in 65° C. waterbath, cover and hold.
6) Heat treat samples in lab heating coil in a 95° C. water bath and hold for 10 minutes at 90° C.
7) Homogenise at 65° C. at 50/20 bar.
8) Cool creams in sink filled with cold water.
9) Add Na azide solution to give 0.02% in creams and store in chiller.

TABLE 3
Composition of formulations of Examples 6 to 8

| | Ex 6 - 20% | Ex 7 - 25% | Ex 8 - 40% |
|---|---|---|---|
| Ingredients | fat Cream | fat cream | fat cream |
| AMF, g | 600 | 750 | 1200 |
| MPC 80, g | 18.3 | 18.3 | 18.3 |
| Stabiliser blend | 4.6 | 3.7 | 2.3 |
| (carrageenan, | | | |
| xanthan, guar | | | |
| gum), g | | | |
| Lecithin, g | 2.1 | 2.4 | 3.9 |
| Mono-diglyceride, g | 2.1 | 2.4 | 3.9 |
| Propylene glycol | 1.5 | 2.1 | 3.3 |
| monostearate | | | |
| (PGMS), g | | | |
| Sodium | 0.6 | 0.6 | 0.6 |
| polyphosphate, g | | | |
| Demin water, g | 2371 | 2220 | 1768 |
| Total, g | 3000 | 3000 | 3000 |

TABLE 4
Composition of formulations of Examples 9 and 10

| | Ex 9 - 28% | Ex 10 - 30% |
|---|---|---|
| Ingredients (g) | fat cream | fat cream |
| AMF | 844 | 900 |
| Whole milk powder | 212.2 | — |
| Skim milk powder | — | 154.5 |
| Demin water | 1917.84 | 1919.55 |
| Mono-diglycerides, | 6.0 | 6.0 |
| Polysorbate | 0.90 | 0.90 |
| Stabiliser blend | 2.55 | 2.55 |
| (carrageenan, | | |
| xanthan, guar | | |
| gum) | | |
| Starch (Pureflo) | 15.00 | 15.00 |
| Sodium | 1.50 | 1.50 |
| polyphosphate | | |
| TOTAL | 3000.00 | 3000.00 |

Three previously described cream compositions were prepared for comparison.

C6, a cream comprising ˜35% w/w fat, was prepared at lab scale according to the method of Example 2 of U.S. Pat. No. 7,658,962. The composition of C6 is provided in Table 5.

TABLE 5
Composition of formulation C6

| Ingredients | %, w/w | Wt, g for 3000 g batch |
|---|---|---|
| AMF | 35 | 1050 |
| Buttermilk powder | 4 | 120 |
| Starch | 1 | 30 |
| Maltodextrin 15 DE | 1.3 | 39 |
| Lecithin | 0.15 | 4.5 |
| Guar gum | 0.15 | 4.5 |
| Tween 60 (Polysorbate) | 0.2 | 6.0 |
| Mono/diglycerides* | 0.2 | 6.0 |
| Locust bean gum | 0.075 | 2.25 |
| Disodium phosphate | 0.1 | 3.0 |
| Demin water | 57.825 | 1734.75 |
| TOTAL | 100.00 | 3000.00 |

C7 and C8, creams comprising 39.8% and 39.8% w/w fat, respectively, were prepared at lab scale according to the method of Example 1 of JP 2004107535A. The composition of C8 and C9 is provided in Table 6.

TABLE 6
Composition of formulations C7 and C8

| | Cream 7 | Cream 7 | Cream 8 | Cream 8 |
|---|---|---|---|---|
| Ingredients | % w/w | Wt, g | % w/w | Wt, g |
| Unsalted butter | 18.1 | 543 | 18.1 | 543 |
| (~82% fat) | | | | |
| Cream (50% fat) | 50.0 | 1500 | 50.0 | 1500 |
| Skim milk powder | 2.0 | 60 | 2.0 | 60 |
| Sorbitan tristearate | 0.2 | 6 | 0.2 | 6 |
| (Span 65) (HLB 2-3) | | | | |
| Lecithin | 0.4 | 12 | 0.4 | 12 |
| Glycerol | 0.1 | 3 | 0.1 | 3 |
| monostearate (HLB | | | | |
| 4.3) | | | | |
| Sucrose ester (HLB | 0.2 | 6 | — | — |
| 11) Sugar Ester S- | | | | |
| 1170 | | | | |
| Sucrose palmitate | — | — | 0.2 | 6 |
| (HLB 15) Sugar Ester | | | | |
| P-1570 | | | | |
| Sodium | 0.1 | 3 | 0.1 | 3 |
| polyphosphate | | | | |
| Guar gum | 0.02 | 0.6 | 0.02 | 0.6 |
| Water | 28.88 | 866 | 28.88 | 866 |
| Total, g | 100 | 3000 | 100 | 3000 |

The creams were characterised using the methods described above for Examples 1-5. All products were cooled to 5° C. before testing. The results are provided in Table 7.

TABLE 7
Characteristics of Ex 6-10 and C6-C8.

| | | | | | | Post-cycling* | | | |
|---|---|---|---|---|---|---|---|---|---|
| | | | | | | | % | Cream | % |
| | Pre-cycling | | | | | | Change | FG | Change |
| | | | Viscosity | Cream | | | In | D[4,3] | In |
| | | | Ratio | FG | | | Viscosity | After | D[4,3] |
| | CAV^{a} | APAV^{b} | (no | D[4,3] | Overrun | CAV | After | Cycling | After |
| Sample | (mPa · s) | (mPa · s) | Units) | (μm) | (%) | (mPa · s) | cycling | (μm) | cycling |
| Ex 6 | 368 | 1060 | 0.35 | 1.96 | 0 | 287 | 22.01 | 1.91 | −2.55 |
| Ex 7 | 244 | 789 | 0.31 | 1.68 | 145 | 235 | 3.69 | 1.55 | −7.74 |
| Ex 8 | 237 | 403 | 0.59 | 1.98 | 184 | 270 | −13.92 | 1.96 | −1.01 |
| Ex 9 | 726 | 149 | 4.87 | 2.03 | 158 | 751 | −3.44 | 2.37 | 16.75 |
| Ex 10 | 853 | 145 | 5.88 | 1.94 | 173 | 955 | −11.96 | 2.05 | 5.67 |
| C6 | 7980 | 833 | 9.58 | 2.43 | 159 | Not | — | 4.20 | 72.84 |
| | | | | | | pourable | | | |
| C7 | 324 | 3 | 108 | 1.38 | 198 | 17,700 | −5363 | 2.55 | 84.78 |
| C8 | 313 | 3 | 104 | 1.15 | 208 | 560 | −78.91 | 1.22 | 6.09 |

^{a}composition apparent viscosity;
^{b}aqueous phase apparent viscosity;
*1 cycle from 25° C. to 10° C.
0% overrun (Ex 6) means that after 5 minutes whipping, the cream contained air bubbles but did not form a stable foam. The bubbles collapsed on cessation of whipping. Not pourable (C7) means that the cream thickened after temperature cycling and could not be poured from the container on tilting.

### INDUSTRIAL APPLICATION

The present invention provides UHT cream compositions resistant to temperature cycling/fluctuations/heat-shock having emulsion stability, pourability, functional performance including whipping ability. The present invention thus has a wide range of applications within the food industry, including whippable creams for toppings and fillings for cakes, as decorating creams, as fillings for pastry like éclairs, crème pies or doughnuts, as beverage toppings, in mousses. In the unwhipped state the creams can be used e.g. as dessert creams, custard creams, in sauces, dressings, ganache, and as coffee creams. Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

In addition, where features or aspects of the invention are described in terms of Markush groups, those skilled in the art will recognise that the invention is also thereby described in terms of any individual member or subgroup of members of the Markush group.

1. A cream composition comprising
a) about 25% to about 40% by weight lipid, the lipid comprising one or more mammalian milk lipids;
b) about 0% to about 3% by weight protein;
c) about 0.01% to about 1.0% by weight of one or more emulsifiers;
d) about 0.05% to about 3% by weight of one or more thickeners or stabilisers;
wherein
e) the ratio of the viscosity of the composition to the viscosity of an extracted aqueous phase of the composition is less than about 20 when measured at a shear rate of 1 s⁻¹ at 5° C.; and/or
f) the composition exhibits an overrun of at least about 80% when whipped at 4 to 10° C. using a bowl and whisk; and/or
g) the composition exhibits a change in apparent viscosity of less than about 100% measured at a shear rate of 1 s⁻¹ at 5° C. after holding at 25° C. for 24 hours followed by holding at 10° C. for 24 hours; and/or
h) the composition exhibits a change in fat globule volume weighted mean diameter (D[4,3]) of less than about 100% after holding at 25° C. for 24 hours followed by holding at 10° C. for 24 hours.

2. A composition of claim 1, wherein the lipid comprises cream, high fat cream, reconstituted cream powder, anhydrous milk fat (AMF), or any combination of any two or more thereof.

3. A composition of either claim 1 or claim 2, wherein the protein comprises milk, skim milk, cream, whole milk, whole milk powder (WMP), skim milk powder (SMP), buttermilk powder (BMP), caseinate, sodium caseinate, calcium caseinate, whey protein concentrate (WPC), whey protein isolate (WPI), milk protein isolate (MPI), milk protein concentrate (MPC), modified MPC derivatives, micellar casein, or any combination of any two or more thereof.

4. A composition of any one of claims 1 to 3, wherein the one or more emulsifiers are selected from the group consisting of protein, phospholipid from milkfat globule membrane, buttermilk powder, β-serum powder, lecithin, mono and diglycerides, distilled monoglycerides, acid esters of mono-diglycerides including lactic, citric, acetic, diacetyltartaric and tartaric, polysorbates, sorbitan esters of fatty acids, sucrose esters, polyglycerol esters of fatty acids, propylene glycol esters of fatty acids, sodium or calcium stearoyl lactylate, or any combination of any two or more thereof.

5. A composition of any one of claims 1 to 4, wherein the one or more emulsifiers comprise two or more of lecithin, mono and diglycerides, polysorbates, sucrose esters, and propylene glycol esters of fatty acids.

6. A composition of any one of claims 1 to 5, wherein the one or more thickeners or stabilisers are selected from the group consisting of carrageenan, guar gum, locust bean gum, Tara gum, gellan gum, xanthan gum, acacia gum, microcrystalline cellulose (MCC), carboxymethyl cellulose (CMC), cellulose derivatives, propylene glycol alginate, sodium alginate, pectin, gelatin, starch or starch derivatives, or citrus fibre, or any combination of any two or more thereof.

7. A composition of any one of claims 1 to 6, wherein the one or more thickeners or stabilisers comprise xanthan, carrageenan, and guar gum.

8. A composition of any one of claims 1 to 7 further comprising a buffering or chelating salt.

9. A composition of any one of claims 1 to 8 further comprising a buffering or chelating salt comprising sodium or potassium polyphosphate.

10. A composition of any one of claims 1 to 9 comprising about 0.05% to about 1% by weight of one or more thickeners or stabilisers.
